(19) United States
(12) Patent Application Publication
(10) Pub. No.: US 2014/0377457 A1
(43) Pub. Date: Dec. 25, 2014

(54) METHOD OF FORMING METAL NANOPARTICLE DISPERSION AND DISPERSION FORMED THEREBY

(71) Applicant: Xerox Corporation, Norwalk, CT (US)

(72) Inventors: Ping Liu, Mississauga (CA); Yiliang Wu, Mississauga (CA); Anthony James Wigglesworth, Oakville (CA)

(21) Appl. No.: 13/925,562

(22) Filed: Jun. 24, 2013

(51) Int. Cl. C09D 11/00

(52) U.S. Cl. CPC C09D 11/52
USPC 427/123; 252/514

(57) ABSTRACT

A metal nanoparticle dispersion is made by mixing ingredients. The ingredients comprise a solvent; a plurality of metal nanoparticles, the metal nanoparticles comprising an oxide formed thereon; and a reducing agent. The reducing agent is included in an amount sufficient to react with the oxide to significantly increase a conductivity of a metal film that is formable from the nanoparticle dispersion using a deposition and heating process compared with the conductivity of a metal film formable from the same nanoparticle composition without the reducing agent using the same deposition and heating process. Methods for making the metal nanoparticle dispersion, as well as for making a film from the dispersion, are also disclosed.

### DETAILED DESCRIPTION

1. Field of the Disclosure

The present disclosure is directed to a method of forming a dispersion of metal nanoparticles that can be used to form a conductive metal film.

2. Background

Solution processable conducting materials including metal nanoparticles play an important role in the electronic industry. Solution processable metal nanoparticles can be used to fabricate various conducting features in electronic devices such as electrodes and electrical interconnectors by low-cost solution deposition and patterning techniques. The conductive features formed from metal nanoparticles can be chosen to provide sufficient conductivity to enable proper operations for the electronic devices fabricated.

Metal nanoparticles are known to be dispersed in liquid solutions that can be deposited onto a desired substrate to form conductive metal films. The dispersions can be deposited in a variety of ways, such as by spin coating techniques or as in ink using an inkjet printer.

However most metal nanoparticle dispersions, including metal nanoparticle inks, are not air stable. They can be easily oxidized to form a certain degree of metal oxide on the surfaces of the metal nanoparticles when stored, even in a cooled environment or under vacuum conditions. This can result in a significantly reduced conductivity for the aged metal nanoparticle inks.

It would be considered an advancement in the art to develop effective methods to improve conductivity for aged metal nanoparticle dispersions.

### SUMMARY

An embodiment of the present disclosure is directed to a metal nanoparticle dispersion. The dispersion is made by mixing ingredients comprising a solvent; a plurality of metal nanoparticles, the metal nanoparticles comprising an oxide formed thereon; and a reducing agent. The reducing agent is included in an amount sufficient to react with the oxide to significantly increase a conductivity of a metal film that is formable from the nanoparticle dispersion using a deposition and heating process compared with the conductivity of a metal film formable from the same nanoparticle composition without the reducing agent using the same deposition and heating process.

Another embodiment of the present disclosure is directed to a method. The method comprises providing a metal nanoparticle dispersion made by mixing ingredients comprising (a) a solvent and (b) a plurality of metal nanoparticles, the metal nanoparticles comprising an oxide formed thereon. A reducing agent is mixed with the metal nanoparticle dispersion. The reducing agent is included in the dispersion in an amount sufficient to react with the oxide to significantly increase the conductivity of a metal film formable from the nanoparticle dispersion using a deposition and heating process compared with the conductivity of a metal film formable from the same nanoparticle dispersion without the reducing agent using the same deposition and heating process.

Yet another embodiment of the present disclosure is directed to a nanoparticle dispersion. The nanoparticle dispersion is made by mixing ingredients comprising: a solvent; a plurality of metal nanoparticles, the metal nanoparticles comprising silver and an oxide, and a reducing agent. The reducing agent is in a concentration ranging from about 0.01 wt. % to about 5 wt. %, based on the total weight of the nanoparticle dispersion.

It is to be understood that both the foregoing general description and the following detailed description are exemplary and explanatory only and are not restrictive of the present teachings, as claimed.

### DESCRIPTION OF EMBODIMENTS

### Metal Nanoparticle Dispersions

An embodiment of the present disclosure is directed to a metal nanoparticle dispersion. The dispersion is made by mixing ingredients comprising: a solvent, a plurality of metal nanoparticles and a reducing agent. The metal nanoparticles include an oxide formed thereon. The reducing agent is included in an amount sufficient to react with the oxide on the nanoparticles to significantly increase a conductivity of a metal film that is formable from the nanoparticle dispersion.

### Solvents

Any suitable solvent can be employed in the dispersions of the present disclosure. In an embodiment, the solvent is a non-aqueous solvent. In an embodiment, the solvent is a polar or non-polar organic solvent. In an embodiment, the solvent facilitates the dispersion of the metal nanoparticles.

Examples of the solvent may include, for example, aromatic hydrocarbons such as benzene, toluene, xylene, ethylbenzene, chlorobenzene, dichlorobenzene, trichlorobenzene, nitrobenzene, cyanobenzene, decalin and tetralin; an alkane, alkene or an alcohol having from about 10 to about 18 carbon atoms such as, undecane, dodecane, tridecane, tetradecane, hexadecane, hexadecane, 1-undecanol, 2-undecanol, 3-undecanol, 4-undecanol, 5-undecanol, 6-undecanol, 1-dodecanol, 2-dodecanol, 3-dodecanol, 4-dodecanol, 5-dodecanol, 6-dodecanol, 1-tridecanol, 2-tridecanol, 3-tridecanol, 4-tridecanol, 5-tridecanol, 6-tridecanol, 7-tridecanol, 1-tetradecanol, 2-tetradecanol, 3-tetradecanol, 4-tetradecanol, 5-tetradecanol, 6-tetradecanol, 7-tetradecanol, and the like; an alcohol, such as for example, terpineol (α-terpineol), β-terpineol, geraniol, cineol, cedral, linalool, 4-terpineol, lavandulol, citronellol, nerol, methol, bomeol, hexanol heptanol, cyclohexanol, 3,7-dimethylocta-2,6-dien-1-ol, 2-(2-propyl)-5-methyl-cyclohexane-1-ol and the like; isoparaffinic hydrocarbons, such as, for example, isodecane, isododecane, and commercially available mixtures of isoparaffins such as ISOPAR® E, ISOPAR G, ISOPAR H, ISOPAR L and ISOPAR M (all the above-mentioned manufactured by Exxon Chemical Company), SHELLSOL® (made by Shell Chemical Company), SOLTROL® (made by Philips Oil Co., Ltd.), BEGASOL® (made by Mobil Petroleum Co., Inc.) and IP Solvent 2835 (made by Idemitsu Petrochemical Co., Ltd.); naphthenic oils; ethers, such as tetrahydrofuran; nitriles, such as acetonitrile; halogenated solvents, such as dichloromethane; amides such as N,N-dimethylformamide (DMF); and mixtures of any of the above solvents. One, two, three or more solvents may be used.

In embodiments where two or more solvents are used, each solvent may be present at any suitable volume ratio or weight ratio, such as, for example from about 99 (first solvent):1 (second solvent) to about 1 (first solvent):99 (second solvent), including the volume ratio or weight molar ratio from about 80 (first solvent):20 (second solvent) to about 20 (first solvent):80 (second solvent). For example, the solvent may a mixture comprised of a solvent selected from the group consisting of terpineol, hexanol, heptanol, cyclohexanol, 3,7-dimethylocta-2,6-dien-1-ol, 2-(2-propyl)-5-methyl-cyclohexane-1-ol, and the like, and at least one hydrocarbon solvent selected from the group consisting of decalin, hexadecane, hexadecene and 1,2,4-trimethylbenzene.

The solvent may be present in the metal nanoparticle dispersion in an amount of at least 10 wt. %, based on the wt. % of the entire dispersion, such as, for example from about 10 wt. % to about 90 wt. %, from about 20 wt. % to about 80 wt. %, from about 30 wt. % to about 70 wt. % and from about 40 wt. % to about 60 wt. % of the dispersion. In an embodiment, the solvent is at least 50 wt. %, based on the wt. % of the entire dispersion.

### Metal Nanoparticles

The term “nano” as used in “metal nanoparticles” refers to, for example, a particle size of 1,000 nm or less, such as, for example, from about 0.5 nm to about 1,000 nm, for example, from about 1 nm to about 500 nm, from about 1 nm to about 100 nm, from about 1 nm to about 25 nm or from about 1 nm to about 10 nm. The particle size refers to the average diameter of the metal particles, as determined by TEM (transmission electron microscopy). Generally, a plurality of particle sizes may exist in the metal nanoparticles obtained from the process described herein. In embodiments, the existence of different sized metal-containing nanoparticles is acceptable.

In embodiments, the metal nanoparticles are composed of (i) one or more metals or (ii) one or more metal composites. Any suitable metals can be employed. Examples of metals include Al, Ag, Au, Pt, Pd, Cu, Co, Cr, In, and Ni, particularly the transition metals, such as, Ag, Au, Pt, Pd, Cu, Cr, Ni, and mixtures thereof. Suitable metal composites may include Au—Ag, Ag—Cu, Ag—Ni, Au—Cu, Au—Ni, Au—Ag—Cu, and Au—Ag—Pd. The metal composites may also include non-metals, such as, for example, Si, C, and Ge. The various components of the metal composite may be present in an amount ranging for example from about 0.01% to about 99.9% by weight, particularly from about 10% to about 90% by weight.

In an embodiment, the metal nanoparticles comprise silver. For example, the metal of the nanoparticles can be a metal alloy composed of silver and one, two or more other metals, with silver comprising, for example, at least about 20% of the nanoparticles by weight, particularly greater than about 50% of the nanoparticles by weight. Unless otherwise noted, the weight percentages recited herein for the components of the metal nanoparticles do not include the weight of any stabilizer or oxide formation that may be part of the nanoparticle.

The metal nanoparticles may be a mixture of two or more bimetallic metal nanoparticle species, such as those described in commonly assigned U.S. patent application Ser. No. 12/113,628 to Naveen Chopra et al. filed May 1, 2008, which is incorporated herein by reference in its entirety, or a bimodal metal nanoparticle, such as those described in U.S. patent application Ser. No. 12/133,548 to Michelle N. Chretien filed Jun. 5, 2008 now U.S. Pat. No. 7,749,300, which is also incorporated herein by reference in its entirety.

The dispersions of the present disclosure can include any suitable amount of metal nanoparticles. In an embodiment, the metal nanoparticles are in a concentration ranging from about 15 wt. % to about 90 wt. %, such as about 30 wt. % to about 60 wt. %, such as about 40 wt. % to about 70 wt. %, based on the total weight of the dispersion.

The metal nanoparticles can include a surface oxide prior to mixing with the reducing agent. The oxide can be formed during aging of the dispersion and may be capable of causing partial or complete loss of conductivity of a film formed using the nanoparticle dispersion.

### Reducing Agent

Any suitable reducing agent capable of removing oxide from the metal nanoparticles and/or increasing the conductivity of a film formed from the nanoparticles can be used. In embodiments, the reducing agent compound may include a hydrazine compound. As used herein, the term “hydrazine compound” includes hydrazine (N₂H₄) and substituted hydrazines. The substituted hydrazines may include as substituting groups, for example, any suitable heteroatom such as S and O; a hydrocarbyl group having from, for example, about 1 to about 30 carbon atoms, from about 1 carbon atom to about 25 carbon atoms, from about 2 to about 20 carbon atoms or from about 2 to about 16 carbon atoms. The hydrazine compounds can also include any suitable salts and hydrates of the hydrazine compounds listed herein. Examples of such salts include hydrazine acid tartrate, hydrazine monohydrobromide, hydrazine monohydrochloride, hydrazine dichloride, hydrazine monooxalate, and hydrazine sulfate.

Examples of hydrazine compounds include hydrocarbyl hydrazine, for example, RNHNH₂, RNHNHR′ and RR′NNH₂, where one nitrogen atom is mono- or di-substituted with R or R′, and the other nitrogen atom is optionally mono- or di-substituted with R, where each R or R′ is a hydrocarbyl group. Examples of hydrocarbyl hydrazines include, for example, methylhydrazine, tert-butylhydrazine, 2-hydroxyethylhydrazine, benzylhydrazine, phenylhydrazine, tolylhydrazine, bromophenylhydrazine, chlorophenylhydrazine, nitrophenylhydrazine, 1,1-dimethylhydrazine, 1,1-diphenylhydrazine, 1,2-diethylhydrazine, and 1,2-diphenylhydrazine. In an embodiment, the reducing agent is phenylhydrazine.

Unless otherwise indicated, in identifying the substituents for R and R′ of the various hydrazine compounds, the phrase “hydrocarbon group” or “hydrocarbyl group” encompasses both unsubstituted hydrocarbyl groups and substituted hydrocarbyl groups. Unsubstituted hydrocarbyl groups may include, for example, a straight chain or branched alkyl group, a cycloalkyl group, an aryl group, an alkylaryl group, arylalkyl group or combinations thereof. Alkyl and cycloalkyl groups may contain from about 1 to about 30 carbon atoms, from about 5 to 25 carbon atoms and from about 10 to 20 carbon atoms. Examples of alkyl and cycloalkyl groups include, for example, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, or eicosanyl, and combinations thereof. Aryl groups may contain from about 6 to about 48 carbon atoms, from about 6 to about 36 carbon atoms or from about 6 to about 24 carbon atoms. Examples of aryl groups include, for example, phenyl, methylphenyl (tolyl), ethylphenyl, propylphenyl, butylphenyl, pentylphenyl, hexylphenyl, heptylphenyl, octylphenyl, nonylphenyl, decylphenyl, undecylphenyl, dodecylphenyl, tridecylphenyl, tetradecylphenyl, pentadecylphenyl, hexadecylphenyl, heptadecylphenyl, octadecylphenyl or combinations thereof. Substituted hydrocarbon groups may be the unsubstituted hydrocarbon groups described herein which are substituted one, two or more times with, for example, a halogen (chlorine, fluorine, bromine and iodine), a nitro group, a cyano group, an alkoxy group (methoxyl, ethoxyl and propoxy), or heteroaryls. Examples of heteroaryl groups may include thienyl, furanyl, pyridinyl, oxazoyl, pyrroyl, triazinyl, imidazoyl, pyrimidinyl, pyrazinyl, oxadiazoyl, pyrazoyl, triazoyl, thiazoyl, thiadiazoyl, quinolinyl, quinazolinyl, naphthyridinyl, carbazoyl, or combinations thereof.

Examples of salts of the hydrocarbyl hydrazines that can be used include methylhydrazine hydrochloride, phenylhydrazine hydrochloride, benzylhydrazine oxalate, butylhydrazine hydrochloride, butylhydrazine oxalate salt, and propylhydrazine oxalate salt, as well as salts of phenylhydrazine.

Examples of hydrazine compounds also include hydrazides, for example, RC(O)NHNH₂, RC(O)NHNHR′ and RC(O)NHNHC(O)R, where one or both nitrogen atoms are substituted by an acyl group of formula RC(O), where each R is independently selected from hydrogen and a hydrocarbyl group, and one or both nitrogen atoms are optionally mono- or di-substituted with R′, where each R′ is an independently selected hydrocarbyl group. Examples of hydrazides may include, for example, formic hydrazide, acethydrazide, benzhydrazide, adipic acid dihydrazide, carbohydrazide, butanohydrazide, hexanoic hydrazide, octanoic hydrazide, oxamic acid hydrazide, maleic hydrazide, N-methylhydrazinecarboxamide, and semicarbazide.

Examples of hydrazine compounds may also include carbazates and hydrazinocarboxylates, for example, ROC(O)NHNHR′, ROC(O)NHNH₂ and ROC(O)NHNHC(O)OR, where one or both nitrogen atoms are substituted by an ester group of formula ROC(O), where each R is independently selected from hydrogen and a hydrocarbyl group, and one or both nitrogen atoms are optionally mono- or di-substituted with R′, where each R′ is an independently selected hydrocarbyl group. Examples of carbazates may include, for example, methyl carbazate (methyl hydrazinocarboxylate), ethyl carbazate, butyl carbazate, benzyl carbazate, and 2-hydroxyethyl carbazate.

Examples of hydrazine compounds may also include sulfonohydrazide, for example, RSO₂NHNH₂, RSO₂NHNHR′, and RSO₂NHNHSO₂R where one or both nitrogen atoms are substituted by a sulfonyl group of formula RSO₂, where each R is independently selected from hydrogen and a hydrocarbyl group, and one or both nitrogen atoms are optionally mono- or di-substituted with R′, where each R′ is an independently selected hydrocarbyl group. Examples of sulfonohydrazides may include, for example, methanesulfonohydrazide, benzenesulfonohydrazine, 2,4,6-trimethylbenzenesulfonohydrazide, and p-toluenesulfonohydrazide.

Other hydrazine compounds may include, for example, aminoguanidine, thiosemicarbazide, methyl hydrazinecarbimidothiolate, and thiocarbohydrazide.

Other reducing agents that can be used include formic acid, formic acid salts, esters of formic acid, substituted or unsubstituted amine borane compounds, oxalic acid, substituted or unsubstituted aldehydes, alkali sulfites and alkaline earth sulfites, among others. One of ordinary skill in the art would be able to readily determine suitable species for any of the above classes of reducing agents without undue experimentation. Combinations of any of the above described reducing agents can potentially be employed.

Reducing agents such as those discussed above are generally well known in the art for making some types of metal nanoparticles. This process can include reacting the reducing agent with a metal precursor compound to produce a metal nanoparticle. Examples of such processes include those described in U.S. Pat. No. 8,057,849; U.S. Pat. No. 7,270,694; and U.S. Pat. No. 7,494,608, the disclosures of each of which are herein incorporated by reference in their entirety. However, the reducing agents are not known for use in the subsequent dispersions that are made using the metal nanoparticles.

One, two, three or more reducing agents may be used. In embodiments where two or more reducing agents are used, each reducing agent may be present at any suitable concentrations that will provide a desired increase in conductivity for the resulting metal layer. Example concentrations of the reducing agent in the metal nanoparticle dispersion include concentrations ranging from about 0.01 wt. % to about 5 wt. %, such as about 0.05 wt. % to about 3 wt. %, or about 0.1 wt. % to about 1 or 2 wt. %, based on the total weight of the metal nanoparticle dispersion. In an embodiment, the concentration of reducing agent is less than 1 wt. %, or less than 0.8 wt. %, or less than 0.5 wt. %, based on the total weight of the metal nanoparticle dispersion.

### Additional Optional Ingredients

The compositions of the present disclosure can include one or more additional optional ingredients suitable for use in metal nanoparticle dispersions. Examples of such optional ingredients include stabilizers and polymeric binders.

Stabilizers are generally well known in the art for enhancing or maintaining the dispersability of nanoparticles and/or to reduce aggregation of the nanoparticles in a dispersion. Any suitable stabilizers can be employed. For example, the organic stabilizer may be an organoamine stabilizer such as those described in U.S. Pat. No. 7,270,694, which is incorporated by reference herein in its entirety. Examples of organoamine stabilizers include alkylamines, such as for example butylamine, pentylamine, hexylamine, heptylamine, octylamine, nonylamine, decylamine, hexadecylamine, undecylamine, dodecylamine, tridecylamine, tetradecylamine, diaminopentane, diaminohexane, diaminoheptane, diaminooctane, diaminononane, diaminodecane, diaminooctane, dipropylamine, dibutylamine, dipentylamine, dihexylamine, diheptylamine, dioctylamine, dinonylamine, didecylamine, methylpropylamine, ethylpropylamine, propylbutylamine, ethylbutylamine, ethylpentylamine, propylpentylamine, butylpentylamine, tributylamine, trihexylamine, and the like, or mixtures thereof.

Examples of other organic stabilizers include thiol and its derivatives, —OC(═S)SH (xanthic acid), polyethylene glycols, polyvinylpyridine, polyvinylpyrolidone, and other organic surfactants. The organic stabilizer may be selected from the group consisting of a thiol such as, for example, butanethiol, pentanethiol, hexanethiol, heptanethiol, octanethiol, decanethiol, and dodecanethiol; a dithiol such as, for example, 1,2-ethanedithiol, 1,3-propanedithiol, and 1,4-butanedithiol; or a mixture of a thiol and a dithiol. The organic stabilizer may be selected from the group consisting of a xanthic acid such as, for example, O-methylxanthate, O-ethylxanthate, O-propylxanthic acid, O-butylxanthic acid, O-pentylxanthic acid, O-hexylxanthic acid, O-heptylxanthic acid, O-octylxanthic acid, O-nonylxanthic acid, O-decylxanthic acid, O-undecylxanthic acid, O-dodecylxanthic acid. Organic stabilizers containing a pyridine derivative (for example, dodecyl pyridine) and/or organophosphine that can stabilize metal nanoparticles may also be used as a potential stabilizer.

Examples of stabilized metal nanoparticles may include: the carboxylic acid-organoamine complex stabilized silver nanoparticles, described in U.S. Patent Application Pub. No. 2009/0148600; the carboxylic acid stabilizer silver nanoparticles described in U.S. Patent App. Pub. No. 2007/0099357 A1, and the thermally removable stabilizer and the UV decomposable stabilizers described in U.S. Patent Application Pub. No. 2009/0181183, each of which is incorporated by reference herein in its entirety.

Polymeric binders are another optional additive that can be employed in the compositions of the present disclosure. Polymeric binders can increase the adhesion of the metal nanoparticles upon deposition to a substrate and/or allow for a conductive film with an increased thickness, such as, for example, up to about 15 micrometers to be deposited on a substrate. The inclusion of a polymeric binder in the composition may also potentially improve the mechanical properties for the deposited conductive feature, such as resistance to scratching, increased flexibility and resistance to cracking. Any polymeric binder may be included in the composition, such that a glass transition temperature of the polymeric binder is lower than the heating temperature for the deposited composition.

Examples of polymeric binders include organic polymeric film forming binders such as thermoplastic and thermosetting resins such as polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl acetate, polysiloxanes, polyacrylates, polyvinyl acetals, polyamides, amino resins, phenylene oxide resins, terephthalic acid resins, phenoxy resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrenebutadiene copolymers, vinylidenechloride-vinylchloride copolymers, vinylacetate-vinylidenechloride copolymers, styrene-alkyd resins, polyvinylcarbazole, and the like. These polymers may be, for example, block, random or alternating copolymers.

### Method of Making the Nanoparticle Dispersions

The present disclosure is also directed to a method of making nanoparticle dispersions. The method comprises providing a metal nanoparticle dispersion made by mixing ingredients comprising (a) a solvent and (b) a plurality of metal nanoparticles. The metal nanoparticles comprising an oxide formed thereon. The oxide can be formed during aging of the dispersion, such as might occur during storage and/or shipping of the dispersion.

The metal nanoparticle dispersion is mixed with a reducing agent. The reducing agent is included in an amount sufficient to react with the oxide on the nanoparticles to significantly increase the conductivity of a metal film formable from the nanoparticle dispersion. After mixing the reducing agent with the metal nanoparticle dispersion, the resulting silver nanoparticle dispersion is ready for fabrication into various conductive features by solution process.

This process provides the ability to store dispersions for longer periods of time, potentially reduces waste and/or allows for increased process flexibility. The compositions of the present disclosure can be stored for any desired length of time prior to use, such as 30 days, 60 days, 90 days, 6 months or a year or more.

### Deposition Processes and Films Formed Thereby

In an embodiment, the dispersions of the present disclosure are deposited on a substrate. The dispersions of the present disclosure can be deposited by any suitable liquid deposition process. Examples of suitable deposition techniques include spin coating, inkjet printing and spraying techniques. Other techniques that are well known in the art include those disclosed in U.S. Pat. No. 8,057,849, the disclosure of which is hereby incorporated by reference in its entirety.

The substrate upon which the metal nanoparticle dispersion is deposited may be any suitable substrate, including, for example, silicon, glass plate, plastic film, sheet, fabric, or paper. For structurally flexible devices, plastic substrates, such as for example polyester, polycarbonate, polyimide sheets and the like may be used. The substrate may have any desired thickness, such as, for example, from about 10 micrometers to over 10 millimeters, such as from about 50 micrometers to about 2 millimeters, or from about 0.4 millimeters to about 10 millimeters.

After deposition, the liquid layer can be heated to form the desired conductive layer. Any suitable temperatures can be employed. The temperatures used can depend on a variety of factors, such as the particular metal nanoparticle dispersion being used, the ability of the substrate to withstand high temperatures, the desired properties of the resulting film, and so forth. Examples include temperatures ranging from about 80° C. to about 200 or 250° C. For example, the deposited composition can be heated to a temperature at or below about 140° C., such as, for example, from about 80° C. to about 140° C., from about 80° C. to about 130° C., from about 80° C. to about 120° C. or from about 80° C. to about 110° C., to induce or “anneal” the metal nanoparticles to form conductive features which are suitable for use as an electrically conductive element.

The heating can be performed for any suitable time ranging from, for example, 1 minute to about 10 hours, from about 5 minutes to about 5 hours and from about 10 minutes to about 3 hours. The heating can be performed in air, in an inert atmosphere, for example, under nitrogen or argon, or in a reducing atmosphere, for example, under nitrogen containing from 1 to about 20 percent by volume hydrogen. The heating can also be performed under normal atmospheric pressure or at a reduced pressure of, for example, from about 1000 mbars to about 0.01 mbars.

As used herein, the term “heating” encompasses any technique(s) that can impart sufficient energy to the heated material or substrate to (1) anneal the metal nanoparticles and/or (2) remove the optional stabilizer from the metal nanoparticles. Examples of heating techniques may include thermal heating (for example, a hot plate, an oven, and a burner), infra-red (“IR”) radiation, a laser beam, microwave radiation, or UV radiation, or a combination thereof.

Heating produces an electrically conductive layer from the deposited metal nanoparticle dispersion. In embodiments, after heating, the resulting electrically conductive layer has a thickness ranging, for example, from about 5 nanometers to about 500 micrometers, such as from about 10 nanometers to about 200 micrometers, or from about 100 nanometers to about 100 micrometers, from about 1 micrometers to about 25 micrometers, or from about 10 micrometers to about 20 micrometers.

The metal films formed by the methods of the present disclosure have conductivities that are significantly greater than the conductivities of films formed from the same nanoparticle compositions without the reducing agent using the same deposition and heating process. For example, the ratio of the conductivity of the metal film formed with reducing agent to the conductivity of the same film formed without reducing agent can be at least 1.5, or at least 2, although it may be several orders of magnitude greater, such as 5, 10, 100, 1000 or 10,000.

The conductivity of the resulting metal films of the present disclosure can vary depending on a number of factors, including the type of metal being deposited and the deposition and annealing process employed. Examples include conductivities greater than 1.0×10⁴ Siemens/centimeter (“S/cm”), such as about 100,000 S/cm, or about 10,000 S/cm to about 50,000 S/cm.

In an embodiment that employs a silver nanoparticle dispersion, annealing at relatively low temperatures (e.g., <120° C.), can produce metal features with conductivities of 1.0×10⁴ S/cm or greater. These conductivities are on a similar level as freshly prepared silver nanoparticle inks, such as are described in the examples below.

### EXAMPLES

As described herein, it has been found that the conductivity of metal nanoparticles and their conductive inks decrease dramatically when stored, even in cooled conditions such in a refrigerator or under vacuum conditions. It is suspected that this may be due to high sensitivity to oxygen in air, which results in a certain amount of metal oxide formation on the surface of the nanoparticles.

### Comparative Examples 1A and 1B

To investigate this matter, two samples of silver thin films were fabricated by spin-coating with two silver nanoparticle inks, both containing about 15 wt. % of silver nanoparticles. Each of the samples was then annealed at a temperature of about 120° C. for about 20 min. Sample B was obtained from a relatively fresh silver nanoparticle dispersion, which resulted in a highly conductive (>10⁴ s/cm) film. Sample A was from an aged silver nanoparticle dispersion. The film formed from Sample A was non-conductive. The two film samples (film A and film B) were provided for a photoemission study to examine the possible different silver valences for the two silver film samples.

The results of the valence band high resolution spectra for examples 1A (film A) and 1B (film B) show very distinct Fermi levels indicating the metallic nature of the two films. The peak positions for the silver 3d_{5/2} and the carbon 1s from the high resolution spectra are shown in the following table.

Table showing distinct Fermi levels of Films A and B

| Photon | Ag Film | Ag Film B | Effective | | |
|---|---|---|---|---|---|
| Energy | A (Ag) | (Ag) | probing depth | A | B |
| (eV) | (3d_{5/2}) | (3d_{5/2}) | (Å) (Ag 3d's) | (C1s) | (C1s) |
| 500 | 368.26 | 368.26 | 5 (Å) | 284.9 | 284.5 |
| 1000 | 368.31 | 368.26 | 10 (Å) | 284.9 | 284.5 |
| 1600 | 368.36 | 368.21 | 15 (Å) | 284.7 | 284.7 |

Since silver in the Ag⁰ state is at 368.2 eV, it is clear that Sample B is still in the Ag⁰ state. See S. Biniak eat al. J of App. Electrochem., 29 (1999) 481, the disclosure of which is hereby incorporated by reference in its entirety. However sample A is not so simple. As we can see from the above table, the binding energy of the 3d_{5/2} shifted from 368.26 eV on the surface at 5 Å to 368.36 eV when effective probing depth moved to 15 Å, suggesting some chemical changes in the film. Since the peak position of the silver reference foil at 500 eV was 368.3 eV, this likely indicates that the surface of film A is partially oxidized. It could also suggest that the silver close to the surface may be partially oxidized as we look deeper into film A.

### Comparative Example 2

### Fresh Silver Nanoparticle Ink

Freshly prepared dodecylamine stabilized silver nanoparticles were used. Fresh 10 g of a silver nanoparticle ink in toluene with solid content at 15 wt % was prepared and spin coated on a glass slide. The film was annealed at about 115-120° C. for 15 min resulting a thin film with 82 nm of thickness. The annealed silver film showed conductivity of 3.6×10⁴ S/cm, measured using 4-probe method. Clearly the fresh prepared dodecylamine stabilized silver nanoparticles showed high conductivity after annealing at processing temperature of about 120° C.

### Comparative Example 3

### Aged Silver Nanoparticle Ink

The above silver nanoparticle ink was kept in a fridge at about 5° C. for over 3 months. The silver nanoparticle ink was spin coated on a glass slide. The coated film was annealed at about 115-120° C. for 15 min, resulting in a thin film of silver with thickness of 85 nm. The annealed thin film was not conductive, measured using a 4-probe method. The annealed film was further annealed at 130° C. for about 20 min and the silver film still remained non-conductive. Clearly the conductivity of the aged dodecylamine stabilized silver nanoparticles was reduced significantly after it was aged.

### Example 1

### Treated Aged Silver Nanoparticle Ink

To 3 g of the same aged silver nanoparticle ink that was used in Comparative Example 3, a small amount of phenyl hydrazine was added (0.01 g, ˜0.3 wt %) with good mixing. A thin film was prepared by spin-coating from this resulting ink. After annealing the coated film at 115-120° C. for 15 min, the resulting Ag film showed a conductivity of about 3.8×10⁴ S/cm, as measured by the 4-probe method.

In summary, the above examples have dearly demonstrated that adding a small amount of reducing agent is an effective way to recover the conductivity for aged metal nanoparticle inks which have been oxidized by the oxygen in air. This method enables aged silver nanoparticle inks to achieve a similar level of high conductivity as freshly prepared silver nanoparticle inks at low processing temperatures. Furthermore, this method has the potential of dramatically reducing manufacturing costs through extension of the shelf life for silver nanoparticle inks and decreasing waste.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications can be made to the Illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompasses by the following claims.

What is claimed is:

1. A metal nanoparticle dispersion made by mixing ingredients comprising:
a solvent;
a plurality of metal nanoparticles, the metal nanoparticles comprising an oxide formed thereon; and
a reducing agent in an amount sufficient to react with the oxide to significantly increase a conductivity of a metal film that is formable from the nanoparticle dispersion using a deposition and heating process compared with the conductivity of a metal film formable from the same nanoparticle composition without the reducing agent using the same deposition and heating process.

2. The dispersion of claim 1, wherein the solvent is a non-polar or polar organic solvent.

3. The dispersion of claim 1, wherein the concentration of solvent is at least 10 wt. % based on the total weight of the composition.

4. The dispersion of claim 1, wherein the metal nanoparticles comprise at least one metal selected from the group consisting of Al, Ag, Au, Pt, Pd, Cu, Co, Cr, In and Ni.

5. The dispersion of claim 1, wherein the metal nanoparticles comprise Ag.

6. The dispersion of claim 1, wherein the metal nanoparticles are in a concentration ranging from about 15 wt. % to about 90 wt. %.

7. The dispersion of claim 1, wherein the reducing agent comprises at least one compound selected from the group consisting of substituted or unsubstituted hydrazines, formic acid, formic acid salts, esters of formic acid, substituted or unsubstituted amine borane compounds, oxalic acid, substituted or unsubstituted aldehydes, alkali sulfites and alkaline earth sulfites.

8. The dispersion of claim 1, wherein the ratio of the conductivity of the metal film formable with the metal nanoparticle dispersion including the reducing agent to the conductivity of the same film formed without reducing agent is at least 1.5.

9. A method comprising:
providing a metal nanoparticle dispersion made by mixing ingredients comprising (a) a solvent and (b) a plurality of metal nanoparticles, the metal nanoparticles comprising an oxide formed thereon; and
mixing a reducing agent with the metal nanoparticle dispersion, the reducing agent being included in the dispersion in an amount sufficient to react with the oxide to significantly increase the conductivity of a metal film formable from the nanoparticle dispersion using a deposition and heating process compared with the conductivity of a metal film formable from the same nanoparticle dispersion without the reducing agent using the same deposition and heating process.

10. The method of claim 9, wherein the metal nanoparticle dispersion has been aged for a period of at least 30 days prior to the mixing of the reducing agent.

11. The method of claim 9, further comprising:
depositing the metal nanoparticle dispersion onto a substrate to form a nanoparticle film; and
heating the deposited nanoparticle film to form a conductive metal film.

12. The method of claim 11, wherein the metal film has a conductivity that is greater than 1.0×10⁴ S/cm.

13. The method of claim 11, wherein the annealing is performed at a temperature ranging from about 80° C. to about 250° C.

14. The method of claim 9, wherein the solvent is a non-polar or polar organic solvent.

15. The method of claim 9, wherein the metal nanoparticles comprise at least one metal selected from the group consisting of Al, Ag, Au, Pt, Pd, Cu, Co, Cr, In and Ni.

16. The method of claim 9, wherein the metal nanoparticles comprise Ag.

17. The method of claim 9, wherein the reducing agent comprises at least one compound selected from the group consisting of substituted or unsubstituted hydrazines, formic acid, formic acid salts, esters of formic acid, substituted or unsubstituted amine borane compounds, oxalic acid, substituted or unsubstituted aldehydes, alkali sulfites and alkaline earth sulfites.

18. A metal nanoparticle dispersion made by mixing ingredients comprising:
a solvent;
a plurality of metal nanoparticles, the metal nanoparticles comprising silver and an oxide; and
a reducing agent in a concentration ranging from about 0.01 wt. % to about 5 wt. %, based on the total weight of the nanoparticle dispersion.

19. The dispersion of claim 18, wherein the reducing agent is a substituted or unsubstituted hydrazine.

20. The dispersion of claim 19, wherein the concentration of the reducing agent is less than 2 wt. %, based on the total weight of the nanoparticle dispersion.
